(19) United States
(12) Patent Application Publication
(10) Pub. No.: US 2014/0146673 A1
(43) Pub. Date: May 29, 2014

(54) SELECTION OF VIRTUAL NETWORK ELEMENTS

(71) Applicant: VERIZON PATENT AND LICENSING INC., Basking Ridge, NJ (US)

(72) Inventor: Benjamin J. PARKER, Foster City, CA (US)

(73) Assignee: VERIZON PATENT AND LICENSING INC., Basking Ridge, NJ (US)

(21) Appl. No.: 13/685,229

(22) Filed: Nov. 26, 2012

(51) Int. Cl. H04L 12/56

(52) U.S. Cl. CPC H04L 47/10
USPC 370/235; 370/329; 370/252

(57) ABSTRACT

A server may be configured to: receive a network selection query, associated with a user device. The network selection query may include information relating to a geographic location of the user device. The server may also select, based on information included in the network selection query, a virtual network element that services the geographic location of the user device and functions as a physical network element of an evolved packet core (EPC) network or an internet protocol (IP) multimedia subsystem (IMS) network. The server may also enable use of the selected virtual network element by the user device; receive a data packet destined for the selected virtual network element; provide the data packet to the selected virtual network element; and prevent the data packet from being sent to a non-selected virtual network element.

### BACKGROUND

A user device may connect with a network element to allow a user to perform a task via the user device (e.g., browse the web, send and/or receive e-mail, etc.). Data flow, associated with performing tasks via the user device, may be cumbersome and redundant when the user device relocates to another geographic location and changes network element connections.

### BRIEF DESCRIPTION OF THE DRAWINGS

FIG. 1 illustrates an example overview of an implementation described herein;

FIG. 2 illustrates an example environment in which systems and/or methods, described herein, may be implemented;

FIG. 3 illustrates example components of a device that may be used within the environment of FIG. 2;

FIG. 4 illustrates an example data structure that may be stored by a server shown in FIG. 2; and

FIG. 5 illustrates a call flow diagram of example operations capable of being performed by an example portion of the environment of FIG. 2.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may connect a user device that relocates from a “home” network (e.g., a network with which the user device is subscribed) to a “roaming” network (e.g., a network that the user device may not be subscribed to but may use to send and/or receive data) to virtual network elements that function as physical network elements (e.g., network devices in an evolved packet core (EPC), network devices in an internet protocol (IP) multimedia subsystem (IMS) network, etc.) associated with the home network of the user device. For example, a virtual network element may include a software image stored on a server to allow the server to function as a physical network element, such as physical network device used to transfer data packets in the context of allowing a user device to perform a task. In some implementations, the server storing the software image associated with the virtual network element may be stored by a data center in a geographic location associated with the roaming network.

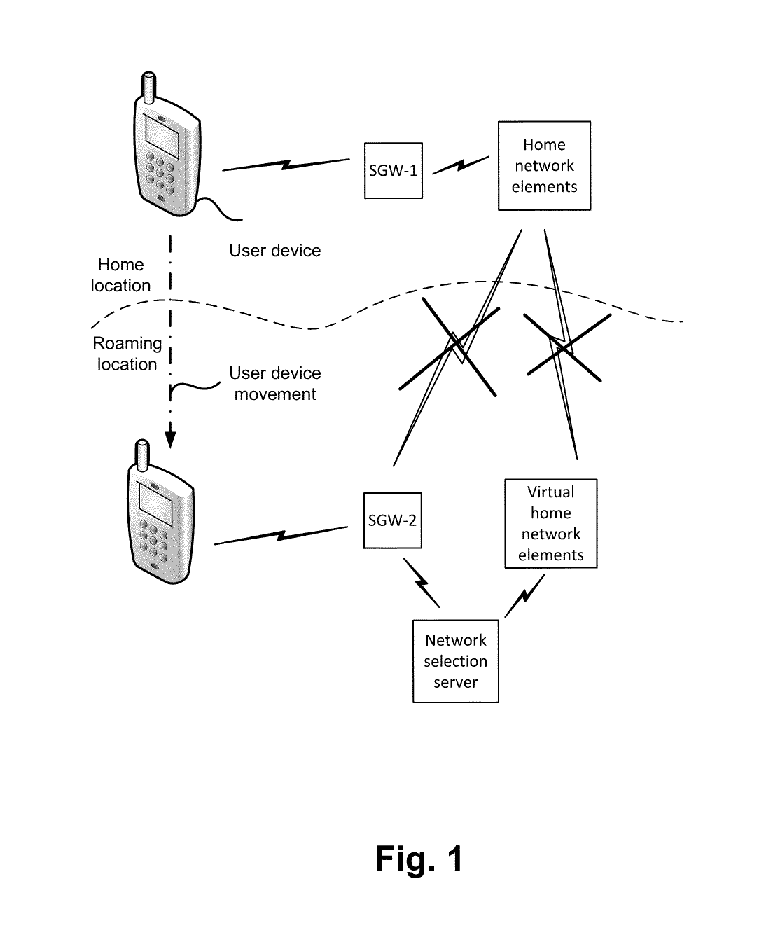

FIG. 1 illustrates an example overview of an implementation described herein. As shown in FIG. 1, assume that a user device is located in a first geographic location (e.g., a “home” location) and that the user device connects with a first serving gateway (e.g., SGW-1) that is part of a home network. In some implementations, SGW-1 may connect with one or more network elements (e.g., “home” network elements which service the home network) to allow the user device to perform some task. For example, SGW-1 may connect with home network elements to allow the user device to perform a task, such as send and/or receive e-mail, download a computer file (e.g., a video file, an audio file, a text document file, or some other file), browse the web, and/or perform some other function.

As further shown in FIG. 1, assume that the user device relocates to a second geographic location (e.g., a “roaming” location) and that the user device connects with a second SGW (e.g. SGW-2) that is associated with a roaming network. In some implementations, SGW-2 may connect with a network selection server (e.g., by resolving to an internet protocol (IP) address that is advertised by the network selection server) that may identify virtual network elements with which to connect. The network selection server may direct SGW-2 to route data, associate with the user device, to one or more virtual network elements (e.g., “virtual home” network elements which service the “roaming” location and function as physical network elements associated with the home location) to allow the user device to perform some task. By redirecting SGW-2 to the virtual home network elements (instead of the home network elements), the network selection server may reduce delays in servicing the roaming user device. As a result, the user device, via SGW-2, may connect with virtual network elements that function as home network elements and that service a geographic location in which the user device is currently located and/or have network capacity to satisfy a resource demand associated with an application of the user device.

In some implementations, an orchestration server may be used to add, delete, or modify virtual network elements in lieu of adding, deleting, or modifying physical network elements, thereby saving costs associated with adding, deleting, or modifying physical network elements.

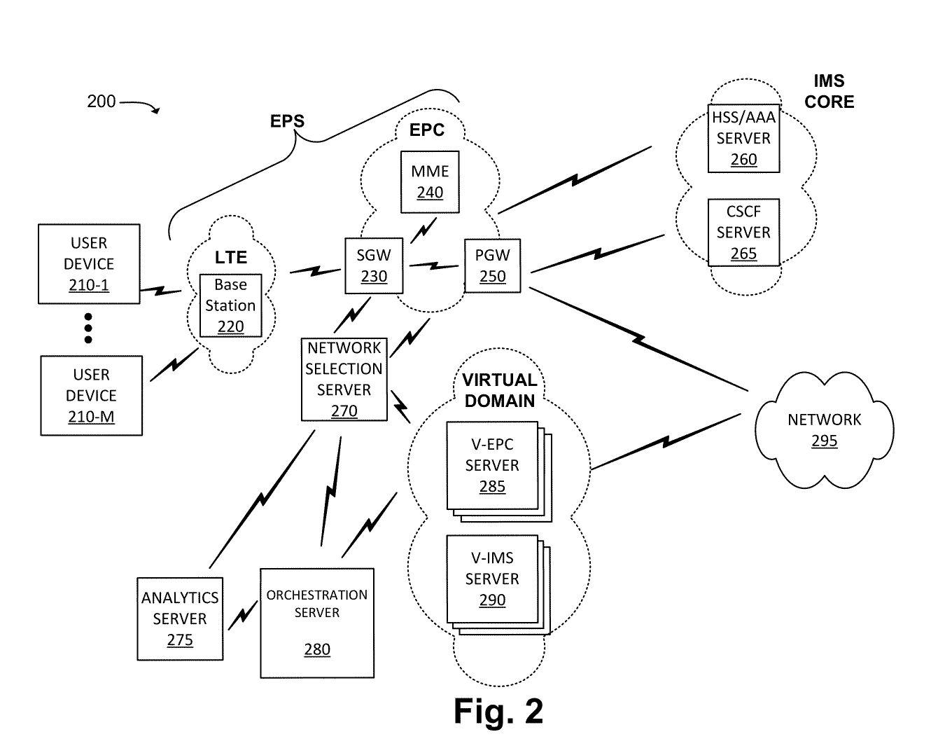

FIG. 2 is a diagram of an example environment 200 in which systems and/or methods described herein may be implemented. As shown in FIG. 2, environment 200 may include user devices 210 . . . 210-M (where M≧1), a base station 220, a serving gateway 230 (referred to as “SGW 230”), a mobility management entity device 240 (referred to as “MME 240”), a packet data network (PDN) gateway (PGW) 250, a home subscriber server (HSS)/authentication, authorization, accounting (AAA) server 260 (referred to as an “HSS/AAA server 260”), a call service control function (CSCF) server 265 (referred to as “CSCF server 265”), network selection server 270, analytics server 275, orchestration server 280, virtual evolved packet core EPC (V-EPC) server 285, virtual Internet protocol (IP) multimedia subsystem IMS (V-IMS) server 290, and a network 295.

Environment 200 may include an evolved packet system (EPS) that includes a long term evolution (LTE) network and/or an EPC that operate based on a third generation partnership project (3GPP) wireless communication standard. The LTE network may be a radio access network (RAN) that includes one or more base stations, such as eNodeBs (eNBs), via which user device 210 communicates with the EPC. As shown in FIG. 2, the LTE network may include base station 220. The EPC may include SGW 230, MME 240, and/or PGW 250 that enables user device 210 to communicate with network 295 and/or an IMS core. The IMS network may include HSS/AAA server 260 and/or CSCF server 265 and may manage authentication, connection initiation, account information, a user profile, etc. associated with user device 210.

Environment 200 may also include a virtual domain including V-EPC server 285 and V-IMS server 290 which may function similarly to a physical EPC and a physical IMS network. In some implementations, servers associated with the virtual domain may be stored by a data center located in a geographic location associated with a roaming network to service user devices 210 located in geographic location associated with the roaming network.

User device 210 may include a device that is capable of communicating with base station 220 and a network (e.g., network 295). For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a laptop computer, a tablet computer, a camera, a personal gaming system, or another type device that is capable of communicating with base station 220.

Base station 220 may include one or more network elements that receive, process, and transmit traffic, such as audio, video, text, and/or other data, destined for and/or received from user device 210. In some implementations, base station 220 may be an eNB device and may be part of the LTE network. Base station 220 may receive traffic from and/or send traffic to network 295 via SGW 230 and PGW 250. Base station 220 may send traffic to and/or receive traffic from user device 210 via an air interface. One or more of base stations 220 may be associated with a RAN, such as the LTE network.

SGW 230 may include one or more network elements, such as a data processing and traffic transfer devices. For example, SGW 230 may include a gateway, a router, a modem, a switch, a firewall, a network interface card (NIC), a hub, a bridge, a proxy server, an optical add-drop multiplexer (OADM), or some other type of device that processes and/or transfers traffic. SGW 230 may, for example, aggregate traffic received from one or more base stations 220 and may send the aggregated traffic to network 295 via PGW 250. In some implementations, SGW 230 may route and forward user data packets, may act as a mobility anchor for a user plane during inter-eNB handovers, and may act as an anchor for mobility between LTE and other 3GPP technologies. For idle state user device 210, SGW 230 may terminate a downlink (DL) data path and may trigger paging when DL data arrives for user device 210.

MME 240 may include one or more network elements that may perform operations associated with a handoff to and/or from the EPS. In some implementations, MME 240 may perform operations to register user device 210 with the EPS, to handoff user device 210 from the EPS to another network, to handoff a user device 210 from the other network to the EPS, and/or to perform other operations. MME 240 may perform policing operations for traffic destined for and/or received from user device 210. MME 240 may authenticate user device 210 (e.g., via interaction with HSS/AAA server 260).

PGW 250 may include one or more network elements, such as a data processing and/or traffic transfer devices. For example, PGW 250 may include a gateway, a router, a modem, a switch, a firewall, a NIC, a hub, a bridge, a proxy server, an OADM, or some other type of device that processes and transfers traffic. PGW 250 may, for example, provide connectivity of user device 210 to external packet data networks by being a traffic exit/entry point for user device 210. PGW 250 may perform policy enforcement, packet filtering, charging support, lawful intercept, and/or packet screening. PGW 250 may also act as an anchor for mobility between 3GPP and non-3GPP technologies.

HSS/AAA server 260 may include one or more network elements, such as a server device, that manages, updates, and/or stores, in a memory associated with HSS/AAA server 260, profile information associated with user device 210. The profile may include information that identifies applications and/or services that are permitted for and/or accessible by user device 210, information associated with bandwidth or data rate thresholds associated with the applications or services, information associated with a user of user device 210 (e.g., a username, a password, a personal identification number (PIN), etc.), rate information, minutes allowed, and/or other information. Additionally, or alternatively, HSS/AAA server 260 may include a device that performs authentication, authorization, and/or accounting (AAA) operations for a communication session associated with user device 210.

CSCF server 265 may include one or more network elements, such as a server device, that processes and routes calls to and from user device 210 via the EPC. For example, CSCF server 265 may process calls, received from network 295, that are destined for user device 210. In another example, CSCF server 260 may process calls, received from user device 210, that are destined for network 295.

Network selection server 270 may include a computing device, such as a server device, or a collection of server devices. In some implementations, network selection server 270 may select virtual network elements with which user device 210 may connect to transfer data packets to and from user device 210 and/or network 295. For example, network selection server 270 may select a virtual network element of V-EPC server 285 or V-IMS server 290, such as a virtual SGW element, a virtual PGW element, etc. In some implementations, network selection server 270 may select virtual network elements based on load-balancing techniques (e.g., based on network activity information), affinity thresholds, round-robin selection techniques, resource demand of a selected application of user device 210, geographic location of a network query, and/or based on some other factor. In some implementations, network selection server 270 may broadcast an IP address to SGW 230 such that SGW 230 may detect and connect with network selection server 270.

In some implementations, network selection server 270 may receive data packets from user device 210 (e.g., via SGW 230) and provide the data packets to selected virtual network elements. Additionally, or alternatively, network selection server 270 may direct SGW 230 to provide data packets to the selected virtual network elements. In some implementations, network selection server 270 may determine analytics data relating to network activity data associated with a network element and may determine overloaded or under-loaded virtual network elements based on the analytics data. Additionally, or alternatively, network selection server 270 may provide the analytics data to analytics server 275. In some implementations, network selection server 270 may function as an authoritative domain name system (DNS) server and/or a caching DNS server.

Analytics server 275 may include a network device, such as a server device, or a collection of server devices. In some implementations, analytics server 275 may receive performance data and thresholds associated with the performance data, from network selection server 270. For example, analytics server 275 may receive analytics data (e.g., data relating to data rates or data throughput), and a threshold value associated with the analytics data associated with a virtual network element of V-EPC server 285 or V-IMS server 290 (e.g., a virtual SGW element, a virtual PGW element, etc.) or a physical network element (e.g., SGW 230, MME 240, and/or PGW 250).

In some implementations, analytics server 275 may identify instances in which the received performance data does not satisfy the threshold value of the performance indicator for the virtual network element. For example, analytics server 275 may identify that the performance data, for a particular performance indicator (e.g., data rate), does not satisfy a threshold value associated with the performance indicator. For example, assume that analytics server 275 receives performance data relating to a data rate of 110 gigabits per second (Gbps). Further, assume that analytics server 275 stores a threshold of greater than 100 Gbps for the data rate performance indicator. In this example, analytics server 275 may determine that the performance data (e.g., 110 Gbps) satisfies the threshold (e.g., greater than 100 Gbps).

In some implementations, analytics server 275 may send instructions to orchestration server 280 to add, remove, combine, or migrate virtual virtual network elements from V-EPC server 285 and/or V-IMS server 290 such that the threshold for the performance indicator is satisfied.

Orchestration server 280 may include a network element, such as a server device or a collection of server devices. In some implementations, orchestration server 280 may store data associated with the topology of V-EPC server 285 and/or V-IMS server 290. For example, orchestration server 280 may store information for a virtual network element (or multiple virtual network elements) associated with V-EPC server 285 and/or V-IMS server 290, such as the type of service and/or function provided by the virtual network element, a virtual IP address associated with the virtual network element, and/or some other information regarding a virtual network element or group of virtual network elements. Orchestration server 280 may also receive an instruction from analytics server 275 to add, remove, or combine virtual network elements based on performance data associated with the virtual network elements. Further, orchestration server 280 may execute the instruction to add, remove, or combine virtual network elements based on receiving the instruction.

V-EPC server 285 may include a network element, such as a server device or a collection of server devices. In some implementations, V-EPC server 285 may store a virtual network element (e.g., in the form of a virtual image file) to allow V-EPC server 285 to function as a physical network element associated with the EPC (e.g., a PGW 250, an SGW 230, an MME 240, and/or some other network element associated with the EPC). In some implementations, V-EPC server 285 may store multiple virtual network elements in a virtual container that services a particular geographic location. For example, V-EPC server 285 may store a first virtual container including virtual network elements that service a first geographic location and a second virtual container including virtual network elements that service a second geographic location. In some implementations, V-EPC server 285 may also include a virtual content delivery network and/or a virtual session delivery network.

V-IMS server 290 may include a network element, such as a server device or a collection of server devices. In some implementations, V-IMS server 290 may store a virtual network element (e.g., in the form of a virtual image file) to allow V-IMS server 290 to function as a physical network element associated with the IMS network (e.g., an HSS/AAA server, a CSCF server, and/or some other network element associated with the IMS network). In some implementations, V-IMS server 290 may store multiple virtual network elements in a virtual container that services a particular geographic location. For example, V-IMS server 290 may store a first virtual container including virtual network elements that service a first geographic location and a second virtual container including virtual network elements that service a second geographic location.

While virtual network elements associated with the EPC are described as being stored by V-EPC server 285 and virtual network elements associated with the IMS network are described as being stored by V-IMS server 290, in practice, virtual network elements associated with the EPC and with the IMS network may be stored by a single server. Further, V-EPC server 285 and/or V-IMS server 290 may include additional virtual network elements, such as a virtual DNS server, a virtual tunnel gateway (TTG), a virtual policy and charging rule function (PCRF), and/or a virtual firewall. In some implementations, V-EPC server 285 and/or V-IMS server 290 may include virtual network elements that may be capable of functioning as a group of physical virtual network elements associated with different geographic locations.

Network 295 may include one or more wired and/or wireless networks. For example, network 295 may include a cellular network, a public land mobile network (PLMN), a second generation (2G) network, a third generation (3G) network, a fourth generation (4G) network, a fifth generation (5G) network, and/or another network. Additionally, or alternatively, network 295 may include a wide area network (WAN), a metropolitan area network (MAN), a telephone network (e.g., the Public Switched Telephone Network (PSTN)), an ad hoc network, an intranet, the Internet, a fiber optic-based network, and/or a combination of these or other types of networks.

The quantity of devices, network elements, and/or networks, illustrated in FIG. 2, is not limited to what is shown. In practice, there may be additional devices, network elements, and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

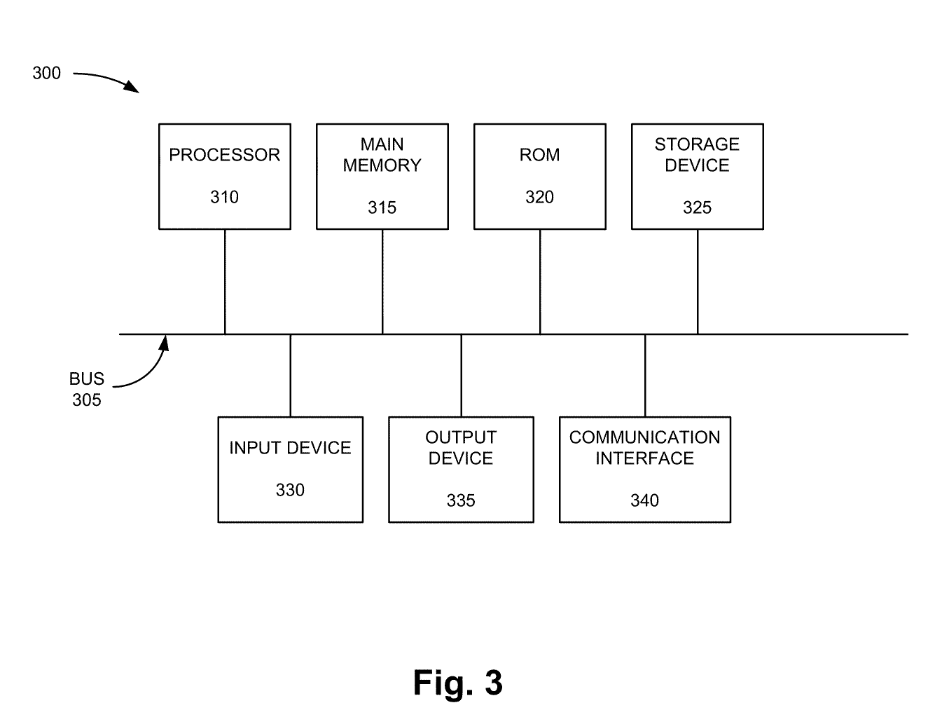

FIG. 3 illustrates example components of a device 300 that may be used within environment 200 of FIG. 2. Device 300 may correspond to user device 210, base station 220, SGW 230, MME 240, PGW 250, HSS/AAA server 260, CSCF 265, network selection server 270, analytics server 275, orchestration server 280, V-EPC server 285, and/or V-IMS server 290. Each of user device 210, base station 220, SGW 230, MME 240, PGW 250, HSS/AAA server 260, CSCF 265, network selection server 270, analytics server 275, orchestration server 280, V-EPC server 285, and/or V-IMS server 290 may include one or more devices 300, and/or one or more components of device 300.

As shown in FIG. 3, device 300 may include a bus 305, a processor 310, a main memory 315, a read only memory (ROM) 320, a storage device 325, an input device 330, an output device 335, and a communication interface 340. In some implementations, device 300 may include additional components, fewer components, different components, or differently arranged components.

Bus 305 may include a path that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a mechanism that permits an operator to input information to device 300, such as a control button, a keyboard, a keypad, or another type of input device. Output device 335 may include a mechanism that outputs information to the operator, such as a light emitting diode (LED), a display, or another type of output device. Communication interface 340 may include any transceiver-like mechanism that enables device 300 to communicate with other devices or networks. In some implementations, communication interface 340 may include a wireless interface, a wired interface, or a combination of a wireless interface and a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include space within a single physical storage device or spread across multiple physical storage devices.

The software instructions may be read into main memory 315 from another computer-readable medium, such as storage device 325, or from another device via communication interface 340. The software instructions contained in main memory 315 may direct processor 310 to perform processes that will be described later. Alternatively, hardwired circuitry may be used in place of or in combination with software instructions to implement processes described herein. Thus, implementations described herein are not limited to any specific combination of hardware circuitry and software.

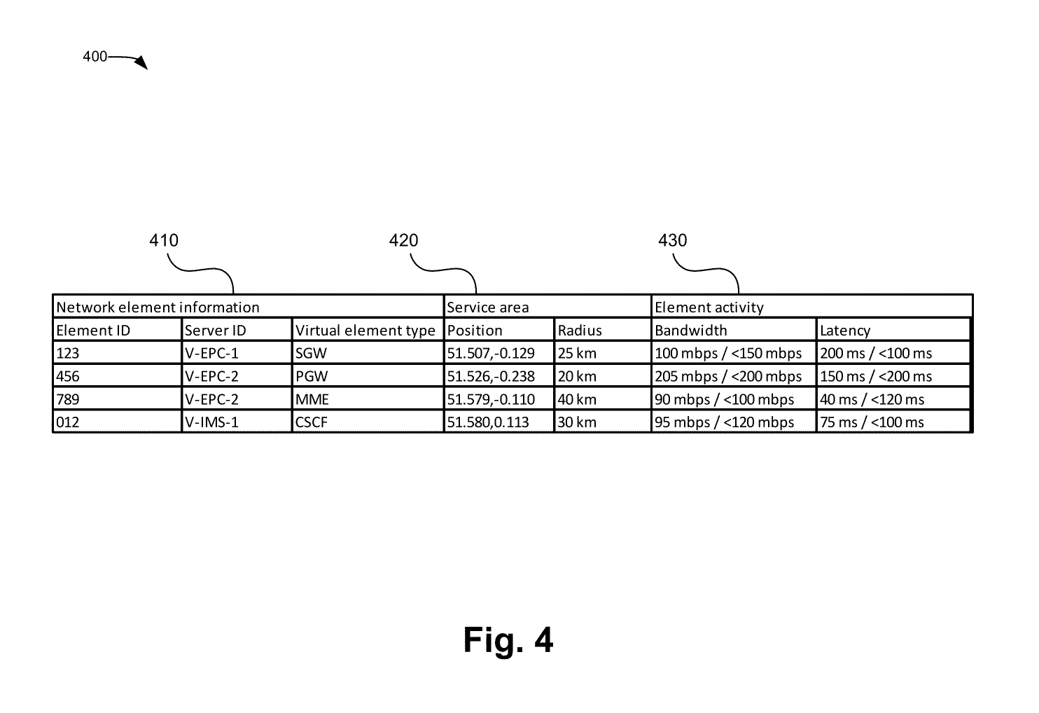

FIG. 4 illustrates an example data structure 400 that may be stored by one or more network elements in environment 200. In some implementations, data structure 400 may be stored in a memory of analytics server 275. In some implementations, data structure 400 may be stored in a memory separate from, but accessible by analytics server 275. In some implementations, data structure 400 may be stored by some other network elements in environment 200, such as SGW 230, MME 240, PGW 250, HSS/AAA server 260, CSCF 265, network selection server 270, orchestration server 280, V-EPC server 285, and/or V-IMS server 290.

A particular instance of data structure 400 may contain different information and/or fields than another instance of data structure 400. In some implementations, data structure 400 may correspond to information associated with geographic service areas of virtual network elements and network activity of the virtual network elements. One instance of data structure 400 may store information regarding one network element in environment 200, whereas another instance of data structure 400 may store information regarding another network element in environment 200. In some implementations, network selection server 270 may select a network element based on information stored by data structure 400.

As shown in FIG. 4, data structure 400 may include virtual network element information field 410, service area field 420, and element activity field 430.

Virtual network element information field 410 may store information for virtual network elements included in environment 200. For example, each entry of virtual network element information field 410 may store information that identifies a virtual network element. In some implementations, a virtual network element may be identified based on an element identifier (ID), a server ID, and a virtual element type. The server ID may store information that identifies a server that stores an image corresponding to the virtual network element (e.g., information that identifies a particular V-EPC server 285 or a particular V-IMS server 290). In some implementations, network element information field 410 may include information that identifies a type of the virtual network element (e.g., a virtual PGW, a virtual SGW, etc.). For example, as shown in FIG. 4, virtual network element information field 410 may store information to identify a virtual SGW having an element ID of 123 and being stored by a server (e.g., V-EPC server 285) having the server ID of V-EPC-1.

Service area field 420 may store information that identifies a service area associated with the virtual network element identified in virtual network element information field 410. For example, service area field 420 may store a center position and a radius corresponding to the service area of a virtual network element. As shown in FIG. 4, service area field 420 may store the center position in the form of longitude and latitude coordinates and may store the radius in distance. For example, service area field 420 may store information to identify the longitude and latitude coordinates of “51.507, −0.129” and the radius 25 kilometers (km) for the virtual network element having the element ID of “123.” In some implementations, service area field 420 may store information that identifies a service area in another way, such as a state border, a province, a zip code, etc.

Element activity field 430 may store information that identifies network activity associated with virtual network elements. In some implementations, element activity field 430 may store network activity in terms of bandwidth, latency, jitter, or in some other form. In some implementations, element activity field 430 may store network activity for a virtual network element in real time or over a period of time. Additionally, element activity field 430 may store information that identifies threshold values in which the virtual network element may be considered to be overloaded. As an example, assume that the virtual network element having the element ID of “123,” is consuming 100 megabytes per second (mbps) of bandwidth and is associated with a threshold that indicates that the virtual network element is capable of handling less than 150 mbps of bandwidth. In this example, element activity field 430 may store information that identifies bandwidth activity (e.g., a real-time bandwidth activity or a bandwidth activity over a period of time) of 100 mbps. Further, element activity field 430 may store information that identifies a threshold value of less than 150 mbps.

Further, assume that the virtual network element having the element ID of “123” has a latency of 200 milliseconds (ms) and a threshold value of less than 100 ms that indicates that the virtual network element is overloaded when the latency of the virtual network element exceeds 100 ms. Further, assume that the virtual network element having the element ID of “123” has a jitter of 50 ms with a threshold value of less than 25 ms that indicates that the virtual network element is overloaded when the jitter of the virtual network element exceeds 25 ms. In some implementations, analytics server 275 may determine that the virtual network element having the ID of “123” may be overloaded since the latency activity value and the jitter activity value do not satisfy their respective threshold values.

In some implementations, analytics server 275 may direct orchestration server 280 to add virtual network elements (e.g., add virtual images representing virtual network elements to a server storing virtual network elements, such as V-EPC server 285 and/or V-IMS server 290) based on determining an overloaded virtual network element. Additionally, or alternatively, analytics server 275 may direct orchestration server 280 to remove a virtual network element (e.g., delete a virtual image representing a virtual network element) based on identifying a substantially under-loaded virtual network element (e.g., when the network activity of a network element satisfies a threshold relating to when the network element is considered to be substantially under-loaded). Additionally, or alternatively, analytics server 275 may direct orchestration server 280 to combine the functions of multiple virtual network elements based on identifying multiple under-loaded virtual network elements.

While particular fields are shown in a particular format in data structure 400, in practice, data structure 400 may include additional fields, fewer fields, different fields, or differently arranged fields than are shown in FIG. 4.

In some implementations, network selection server 270 may advertise an IP address to SGW 230 such that SGW 230 may resolve to the IP address advertised by network selection server 270 (e.g., when user device 210 connects with SGW 230). As described above, network selection server 270 may select virtual network elements with which user device 210 may connect (e.g., via SGW 230), such as virtual network elements in the virtual domain. In some implementations, the virtual domain may include V-EPC server 285 and V-IMS server 290 which may each be provisioned to include one or more virtual images to function as physical network devices associated with a particular network (e.g., a network associated with a home network of user device 210).

For example, V-EPC server 285 may include virtual images to function as SGWs 230, MMEs 240, or PGWs 250 associated with the home network. V-IMS server 290 may include virtual images to function as HSS/AAA servers 260 or CSCF servers 265, associated with the home network, and may include information stored by physical HSS/AAA servers 260 or physical CSCF servers 265 (e.g., subscriber information of user device 210, authorization information of user device 210, etc.). In some implementations, orchestration server 280 may be used to add, modify, or delete virtual images stored by V-EPC server 285 and V-IMS server 290.

In some implementations, the virtual domain may include multiple V-EPC servers 285 and multiple V-IMS servers 290 located in data centers associated with a geographical location of a roaming network which with user device 210 may connect when user device 210 relocates from a home network to the roaming network. As a result, user device 210 may connect with the virtual network elements (e.g., via SGW 230) stored by servers located in the geographical location of the roaming network.

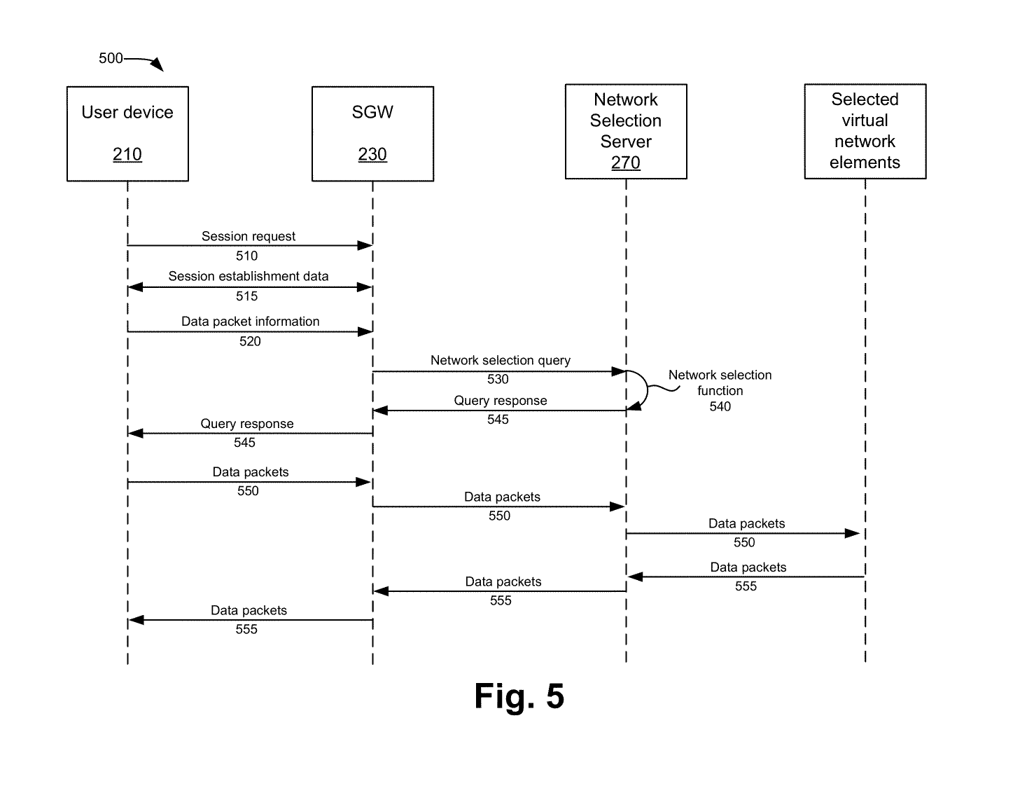

FIG. 5 illustrates a call flow diagram of example operations capable of being performed by an example portion 500 of environment 200. As shown in FIG. 5, portion 500 may include user device 210, SGW 230, network selection server 270, and selected virtual network elements (e.g., virtual network elements selected by network selection server 270 for use by user device 210). In some implementations, portion 500 may include components and/or perform functions described above in connection with, for example, one or more of FIGS. 1-3. FIG. 5 may correspond to example operations that direct user device 210 to connect with virtual network elements that service a geographic location in which user device 210 is currently located and/or with virtual network elements that have capacity to satisfy a network demand of an application of user device 210. For example, user device 210 may connect with virtual network elements via SGW 230 and/or via network selection server 270.

In FIG. 5, assume that user device 210 is located in a geographic location associated with a roaming network and that user device 210 connects with SGW 230 (e.g., via base station 220 that supports the roaming network). Further assume that user device 210 receives a selection of an application (e.g., a web browsing application, a messaging application, etc.). In some implementations, user device 210 may send session request 510 to SGW 230 (e.g., to access network 295 in order to allow user device 210 to send and/or receive data packets in the context of performing a function associated with the selected application). As shown in FIG. 5, SGW 230 and user device 210 may exchange session establishment data 515 (e.g., authentication data or some other session establishment data) to establish a session.

As further shown in FIG. 5, user device 210 may provide SGW 230 with data packet information 520 (e.g., data packets associated with performing a task via an application of user device 210). For example, in the context of performing a web browsing task, data packet information 520 may include a request for data associated with a web page and/or a request for data associated with a computer file stored by a web server. Additionally, or alternatively, data packet information 520 may include some other data associated with performing some other task via an application of user device 210 (e.g., data relating to message sending and/or receiving functions, data relating to placing a voice over IP call, data relating to placing a video over IP call, etc.).

As further shown in FIG. 5, SGW 230 may provide network selection server 270 with network selection query 530. In some implementations, SGW 230 may determine a resource demand associated with data packet information 520 (e.g., a demand for a particular bandwidth, latency, and jitter), and may also determine a location associated with data packet information 520 (e.g., a network location or a geographic location in which data packet information 520 were received from user device 210 as determined by the location of SGW 230). In some implementations, network selection query 530 may include the resource demand associated with data packet information 520, the location associated with data packet information 520, information for a task associated with data packet information 520 (e.g., a task to be performed by user device 210, such as a task relating to message sending and/or receiving functions, placing a voice over IP call, placing a video over IP call, etc.), and/or some other information relating to data packet information 520 or user device 210.

In some implementations, network selection server 270 may perform network selection function 540 based on receiving network selection query 530. For example, network selection server 270 may determine virtual network elements that may receive data packet information 520 in the context of allowing user device 210 to perform a function via an application of user device 210. In some implementations, network selection server 270 may select virtual network elements (e.g., virtual images stored by V-EPC server 285 or V-IMS server 290) based on virtual network elements that service a location associated with a current location of user device 210 and/or a location associated with data packet information 520 (e.g., a network or geographic location of the particular SGW 230 that received data packet information 520 from user device 210).

In some implementations, network selection server 270 may select virtual network elements based on a task to be performed by user device 210. For example, network selection server 270 may select virtual network elements associated with V-EPC server 285 for tasks relating to a web browsing function or for some other task associated with the EPC. Additionally, or alternatively, network selection server 270 may select virtual network elements associated with V-IMS server 290 for tasks relating to message sending and/or receiving functions, tasks relating to placing or receiving telephone calls, or some other task associated with the IMS network.

In some implementations, network selection server 270 may make an initial selection of virtual network elements associated with V-EPC server 285 or V-IMS server 290 based on a type of task to be performed by user device 210, as described above. Further, network selection server 270 may narrow the initial selection based on load-balancing techniques (e.g., by identifying virtual network elements having available network capacity to satisfy a resource demand associated with data packet information 520). In some implementations, network selection server 270 may select virtual network elements in a manner that balances network load across multiple virtual network elements associated with multiple data centers. Additionally, or alternatively, network selection server 270 may select virtual network elements that satisfy a performance threshold (e.g., as determined by information stored by analytics server 275).

Additionally, or alternatively, network selection server 270 may select virtual network elements based on some other technique (e.g., a round robin selection technique, selection of virtual network elements which are least loaded based on network activity information stored by data structure 400). In some implementations, network selection server 270 may enable the selected virtual network elements for use by user device 210 based on performing network selection function 540. In some implementations, network selection server 270 may select virtual network elements based on information stored by data structure 400 (e.g., service area information corresponding to a current location of user device 210 and/or using load-balancing techniques based on network element activity information corresponding to available network capacity to satisfy a resource demand associated with data packet information 520).

As shown in FIG. 5, network selection server 270 may provide query response 545 to SGW 230 including an indication that network selection server 270 has selected virtual network elements and/or enabled use of the selected virtual network elements. Additionally, query response 545 may include information for the selected virtual network elements with which user device 210 may communicate in order to send and/or receive data packets based on performing network selection function 540. In some implementations, query response 545 may include information (e.g., an authentication script or some other authentication mechanism) to allow user device 210 to communicate with the selected virtual network elements (e.g., via SGW 230) in order to send and/or receive data packets to and/or from the selected virtual network elements in order to perform a task via an application of user device 210.

As shown in FIG. 5, user device 210 may receive query response 545 to indicate that network selection server 270 has selected virtual network elements. In some implementations, user device 210 may provide data packets 550 to SGW 230 based on receiving query response 545. Data packets 550 may include, for example, data relating to a communication (e.g., a call, a message, a web browsing instruction, etc.) to be routed by the selected virtual network elements (e.g., in the context of allowing user device 210 to perform a task via an application of user device 210). In some implementations, network selection server 270 may receive data packets 550 (e.g., via SGW 230) and may provide data packets 550 to the selected virtual network elements. Additionally, or alternatively, user device 210 may provide data packets 550 to the selected virtual network elements (e.g., via SGW 230) without involving network selection server 270. In some implementations, (e.g., when data packets are provided to the selected virtual network elements via network selection server 270), network selection server 270 may prevent data packets 550 from being sent to virtual network elements that are not selected.

In some implementations, the selected virtual network elements may provide data packets 555 based on receiving data packets 550. Data packets 555 may include, for example, data relating to a response of data packets 550 (e.g., data relating to a web page requested by user device 210 via data packets 550, data relating to a computer file requested by user device 210 via data packets 550, etc.). As shown in FIG. 5, the selected virtual network elements may provide data packets 555 to user device 210 via network selection server 270 and/or SGW 230. In some implementations, the selected virtual network elements may provide data packets 555 to user device 210 independently of network selection server 270.

While a particular series of operations and/or data flows have been described above with regards to FIG. 5, the order of the operations and/or data flows may be modified in other implementations. Further, non-dependent operations may be performed in parallel. Additionally, the operations and/or data flows are not limited to what is shown in FIG. 5. For example, network selection server 270 may provide analytics information regarding virtual network elements to analytics server 275 such that analytics server 275 may store the analytics information in data structure 400. Additionally, or alternatively, network selection server 270 may communicate with V-EPC server 285 and/or V-IMS server 290 to perform health checks on V-EPC server 285 and/or V-IMS server 290.

As described above, user device 210, via SGW 230, may connect with virtual network elements (e.g., virtual EPC network elements and/or virtual IMS network elements) that service a geographic location in which the user device is currently located and/or with virtual network elements having network capacity to satisfy a resource demand associated with an application of the user device. In some implementations, orchestration server 280 may be used to add, delete, or modify virtual network elements in lieu of the expensive act of installing and/or modifying physical network elements. Additionally, or alternatively, physical network elements may be added, deleted, or modified in accordance with network resource demands associated with a particular geographic location.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method comprising:
receiving, by a first server, a network selection query, associated with a user device,
the network selection query including information relating to a geographic location of the user device;
selecting, by the first server and based on the network selection query, a virtual network element,
the virtual network element servicing the geographic location of the user device and functioning as a physical network element of an evolved packet core (EPC) network or an internet protocol (IP) multimedia subsystem (IMS) network;
enabling, by the first server, use of the selected virtual network element by the user device;
receiving, by the first server and from the user device, a data packet destined for the selected virtual network element; and
providing, by the first server, the data packet to the selected virtual network element.

2. The method of claim 1, where the virtual network element includes at least one of:
a virtual mobility management entity (MME),
a virtual serving gateway (SGW),
a virtual packet data network (PDN) gateway (PGW),
a virtual domain name server (DNS),
a virtual tunnel termination gateway (TTG), or
a virtual firewall.

3. The method of claim 1, where the virtual network element includes at least one of:
a virtual policy and charging rule function (PCRF),
a virtual home subscriber server (HSS), or
a virtual call service control function (CSCF) server.

4. The method of claim 1, further comprising:
determining analytics data associated with the virtual network element,
the analytics data including network activity data associated with the virtual network element; and
providing the analytics data to a second server,
the second server determining an overloaded virtual network element based on the analytics data and directing a third server to add a virtual network element to receive the data packet on behalf of the overloaded network element.

5. The method of claim 4, where the second server determines an under-loaded virtual network element based on the analytics data and directs the third server to remove the under-loaded virtual network element.

6. The method of claim 1, where the network selection query includes information relating to a network resource demand of an application of the user device, the method further comprising:
determining that the network element includes capacity to satisfy the network resource demand,
where the selection of the network element being further based on determining that the virtual network element includes capacity to satisfy the network resource demand.

7. The method of claim 1, further comprising:
determining that the network element is performing in accordance with a performance parameter,
where the selection of the network element being further based on determining that the network element is performing in accordance with the performance parameter.

8. The method of claim 1, further comprising:
receiving an identifier, associated with the user device, as part of the network query,
where selecting the network element is further based on the identifier associated with the user device.

9. A system comprising:
a first server to:
receive a network selection query, associated with a user device,
the network selection query including information relating to a geographic location of the user device or relating to a network resource demand of an application of the user device;
select, based on information included in the network selection query, a virtual network element,
the virtual network element servicing the geographic location of the user device or having capacity to satisfy the network resource demand and functioning as a physical network element of an evolved packet core (EPC) network or an internet protocol (IP) multimedia subsystem (IMS) network;
enable use of the selected virtual network element by the user device;
receive a data packet destined for the selected virtual network element; and
provide the data packet to the selected virtual network element.

10. The system of claim 9, where the virtual network element includes at least one of:
a virtual mobility management entity (MME),
a virtual serving gateway (SGW),
a virtual packet data network (PDN) gateway (PGW),
a virtual domain name server (DNS),
a virtual tunnel termination gateway (TTG), or
a virtual firewall.

11. The system of claim 9, where the virtual network element includes one or more of:
a virtual policy and charging rule function (PCRF),
a virtual home subscriber server (HSS), or
a virtual call service control function (CSCF) server.

12. The system of claim 9, where the first server is further to:
determine analytics data associated with the virtual network element,
the analytics data including network activity data associated with the virtual network element; and
provide the analytics data to a second server,
the second server determining an overloaded virtual network element based on the analytics data and directing a third server to add a virtual network element to receive the data packet on behalf of the overloaded network element.

13. The system of claim 12, where the second server determines an under-loaded virtual network element based on the analytics data and directs the third server to remove the under-loaded virtual network element.

14. The system of claim 9, where the first server is further to:
determine that the network element is performing in accordance with a performance parameter; and
select the network element further based on determining that the network element is performing in accordance with the performance parameter.

15. The system of claim 9, where the first server is further to:
receive an identifier, associated with the user device, as part of the network query; and
select the virtual network element further based on the identifier associated with the user device.

16. A computer-readable medium for storing instructions, the instructions comprising:
a plurality of instructions which, when executed by one or more processors associated with a first server, cause the one or more processors to:
receive a network selection query, associated with a user device,
the network selection query including information relating to a geographic location of the user device or an identifier associated with the user device;
select, based on information included in the network selection query, a virtual network element,
the virtual network element servicing the geographic location of the user device and functioning as a physical network element of an evolved packet core (EPC) network or an internet protocol (IP) multimedia subsystem (IMS) network;
enable use of the selected virtual network element by the user device;
receive a data packet destined for the selected virtual network element;
provide the data packet to the selected virtual network element.

17. The computer-readable medium of claim 16, where the virtual network element includes at least one of:
a virtual mobility management entity (MME),
a virtual serving gateway (SGW),
a virtual packet data network (PDN) gateway (PGW),
a virtual domain name server (DNS),
a virtual tunnel termination gateway (TTG), or
a virtual firewall.

18. The computer-readable medium of claim 16, where the virtual network element includes one or more of:
a virtual policy and charging rule function (PCRF),
a virtual home subscriber server (HSS), or
a virtual call service control function (CSCF) server.

19. The computer-readable medium of claim 16, where the plurality of instructions further cause the one or more processors to:
determine analytics data associated with the network element,
the analytics data including network activity data associated with the network element; and
provide the analytics data to a second server,
providing the analytics to the second server allowing the second server to:
determine an overloaded network element based on the analytics data and directing a third server to add a virtual network element to receive the data packet on behalf of the overloaded network element or
determine an under-loaded virtual network element based on the analytics data and directs the third server to remove the under-loaded virtual network element.

20. The computer-readable medium of claim 16, where the network selection query includes information relating to a network resource demand of an application of the user device, the plurality of instructions further cause the one or more processors to:
determine that the network element includes capacity to satisfy the network resource demand; and
select the network element further based on determining that the network element includes capacity to satisfy the network resource demand.
